(19) United States
(12) Patent Application Publication
(10) Pub. No.: US 2013/0109002 A1
(43) Pub. Date: May 2, 2013

(54) EDUCATIONAL VIRTUAL SPACE

(71) Applicants: Reed Debra Howard, Kalamazoo, MI (US); Paige Eastwood Woolery, Kalamazoo, MI (US); Reed Andrew Howard, Kalamazoo, MI (US); Todd-James Schafer Howard, Kalamazoo, MI (US)

(72) Inventors: Reed Debra Howard, Kalamazoo, MI (US); Paige Eastwood Woolery, Kalamazoo, MI (US); Reed Andrew Howard, Kalamazoo, MI (US); Todd-James Schafer Howard, Kalamazoo, MI (US)

(73) Assignee: Wowzers, LLC, Chicago, IL (US)

(21) Appl. No.: 13/283,232

(22) Filed: Oct. 27, 2011

(51) Int. Cl. G09B 5/00

(52) U.S. Cl. 434/350

(57) ABSTRACT

An educational virtual space facilitates interactions between teachers (including administrators and/or parents) and students (including students taught at home, at school, and elsewhere, as well as any other users). A teacher interface module enables a teacher to guide students through a curriculum of components of educational content within and/or outside of the educational space. Individualized sequences of components are adaptable, e.g. based on student performance information. Student progress is monitored and represented graphically through the teacher interface module.

### FIELD OF THE INVENTION

The invention relates to the provision of an educational virtual space, configured to facilitate interactions between teachers, administrators and/or parents on one hand, and students and/or other users on the other hand in the virtual space.

### BACKGROUND OF THE INVENTION

Learning management systems are known. Systems that provide virtual spaces to users are known.

### SUMMARY

One aspect of the invention relates to a system and method of providing an educational virtual space to users. Users of the system may be teachers, administrators and/or parents (collectively referred to herein as “teachers”) and users and/or students (collectively referred to herein as “students”), or people performing the functions of teachers and students in the context of the educational virtual space. An educational virtual space may comprise an online environment that is accessible to users from distinct computing devices. For example, a teacher may be provided access to the educational virtual space from her client computing device, whereas a student may be provided access to the educational virtual space from a different machine.

The appearance, interface, and functionality of the educational virtual space may be customized to individual users, and may be different for teachers than for students. A system configured to provide the educational virtual space may include one or more of an account setup module, a user account module, a virtual space module, a teacher interface module, a user interface module, a learning path module, a gaming module, a content creation module, a performance module, a reporting module, a leaderboard module, a currency module, and/or other modules.

The educational virtual space may be provided to users such that the users can interact with each other within the educational virtual space. The educational virtual space may provide access to components of educational content. A teacher may be provided control over the experience of one or more students within the educational virtual world, e.g. by selecting a particular set and/or sequence of educational components for the students to complete. Such a set and/or sequence may be referred to as a curriculum. A curriculum may be aligned to standards. One way of organizing content may be to select curricula intended for completion in one day; this may be referred to as a daily curriculum.

A sequence of daily curricula may be referred to as an epoch, e.g. consisting of five daily curricula. A sequence of five epochs may be referred to as an era. Each era, another sequence of epochs is begun anew. Different daily curricula, epochs, and/or eras may correspond to different educational concepts, or have different lengths. Depending on the educational content, different educational concepts may be served by a different organizational structure, different (types of) components of educational content, different lengths, etc. One of the suitable overarching topics of the educational virtual space may be mathematics, including for example algebra, geometry, number sense, and/or other content areas.

The account setup module may be used to set up user accounts. The account setup module may let a teacher set up accounts for her students, regardless of whether the students are taught at a school, at home, or elsewhere. Responsive to the teacher providing a user name and/or other user information, the account setup module provides information, e.g. through an email, to provide secure access for a student to a newly created student account, which may be linked, implicitly or explicitly, to one or more teacher accounts.

The user account module may manage storage for, and provide access to, user information, settings, preferences, customizations, account information, and/or other information.

The virtual space module may be configured to host an educational virtual space to users such that users are able to interact and collaborate with each other in addition to interacting with the educational content within the educational virtual space. The virtual space module may communicate with instances of a user interface that are specific to a user.

The teacher interface module may be configured to control educational content, settings (including levels of difficulty), and/or features pertaining to operations and/or interactions within the educational virtual space for one or more students. For example, a particular lesson, practice, game, quiz, quest, challenge, worksheet, and/or other type of educational content may be selectable through the teacher interface module in order to initiate/commence said educational content for one or more students. Control through the teacher interface module may be manual, automatic, programmable, or otherwise changeable in a predetermined manner.

The teacher interface module may be configured to generate an interface for teachers that presents the progress of one or more students during and/or after completion of one or more components of educational content within the educational virtual space. This interface may depict one or more avatars (representing students), e.g. in a grid, together with representations of one or more components of educational content, e.g. icons. An avatar may be associated with a progress indicator—such as a progress bar—or the placement of an avatar within the interface itself may indicate progress, by virtue of its alignment with or position relative to said representations. The interface may provide control over the current component a student is interacting with, e.g. by dragging and repositioning the appropriate avatar to align with another educational component in the grid of the interface.

The student interface module may be configured to facilitate student interaction within the educational virtual space and/or provide access for a student to views of the educational virtual space, educational content, a user's student account access information, user information, and/or other information. The student user interface may receive inputs and/or commands to control the virtual space and/or objects positioned therein. A student interface may be differentiated for different parts of an epoch or era. For example, the student interface module may enable students to control their avatars directly through their respective student interface modules during the first four days of an epoch, or their buzzpods directly during the last day of an epoch. Note that interaction between students may enhance the educational content and/or the coherence thereof.

The student interface module may be configured to generate an interface for students that presents a view of multiple avatars concurrently, representing active students within the educational virtual space, wherein the students are interacting with each other through their respective avatars. Available components of educational content may promote collaboration within the education virtual space.

The performance module may be configured to track a student's performance on various components of educational content and/or derive or compile performance information for a student. Performance information may be based on teacher input in addition to events that transpired within the education virtual space. Performance information may include an evaluation of a student's progress through a component of educational content, such as e.g. a quiz.

The performance module may be configured to perform a granular assessment of a student's progress. For example, granular assessment may determine, e.g. through analysis, whether the set of incorrect answers supplied during a student's interaction with a component of educational content indicates a particular area (i.e. an educational concept and/or content area and/or a constituent component thereof) of less-than-average comprehension for a student. Educational concepts may be organized according to a hierarchy of conceptual levels within the educational virtual space. The areas analyzed for the purpose of granular assessment may correspond to (components of) standardized tests as commonly used to assess conceptual comprehension. For example, the content area may include arithmetic manipulation of fractions at a given conceptual level in the hierarchy of conceptual levels. Through granular assessment it may be revealed that specifically improper fractions—which may be organized at a different conceptual level then basic arithmetic manipulation of fractions—appear to be an area of less-than-average comprehension for a given student.

Quantifying performance for a particular area (i.e. a subset of the concepts covered in a particular component of educational content) provides an opportunity for targeted improvement, review, and/or practice, e.g. through additional educational content within the educational virtual space. Such targeted educational content may be referred to as granular.

The performance module may be configured to export performance information in a format suitable for systems outside the educational virtual space. The performance module may be configured to import performance information, e.g. based on standardized tests, from systems outside of the educational virtual space. External performance data may be student specific and/or pertaining to multiple students.

The reporting module may be configured to present and/or export any information from any module within the system configured to provide the educational virtual space to a teacher, student, and/or other party, within appropriate bounds. The reporting module may aggregate some or all of the information, e.g. provide the average score of an entire class.

The learning path module may be configured to provide an initial learning path (i.e. a sequence of components of educational content that are part of a curriculum) for a student, e.g. responsive to selections received from a teacher. An initial learning path may be based on structured groups of daily curricula or epochs. An epoch may for example comprise four daily curricula intended to introduce a particular educational concept, followed by one daily curriculum intended to test and/or review said educational concept. An initial learning path may be based on an era of epochs. An initial learning path may include settings such as a particular level of difficulty for some or all of the educational content that is part of the initial learning path.

As a student progresses through a learning path, the learning path module may automatically and/or manually (i.e. responsive to control by a teacher) adapt the learning path—thus creating a flexible learning path or adaptive learning path—based on student performance, performance information, teacher input, and/or other information. This adaptation may occur continuously, intermittently, periodically, ad hoc, as scheduled, and/or at other moments. For example, the learning path module may, for an educational component such as a quiz, add or substitute problems that are targeted to a particular area corresponding to a granular assessment of the level of comprehension of a given student. Customization of the learning path may be based on imported information related to standardized tests, completed outside of the educational virtual space.

The learning path module may be configured to create and/or provide educational materials and/or instructions, e.g. to a teacher, that are intended to supplement the academic experience provided through/by the educational virtual space. These supplemental materials and/or instructions may include educational components designed to take place outside of the educational virtual space. By teaching educational concepts, such as e.g. a mathematical operation, both online and offline, students may gain improved comprehension of said concept. This process may be referred to as blended learning. Blended learning may include higher order thinking discussions that require students to think critically about questions, skills, and concepts. Higher order thinking discussions may e.g. give students an opportunity to apply theoretical skills to real life situations. Blended learning may also include activities and instructions offline that may supplement other education content, e.g., but not limited to, online content.

The gaming module may be configured to provide gaming elements and/or gaming components within the system configured to provide the educational virtual space. Alternatively, and/or simultaneously, the gaming module may provide a link from the educational virtual space to external systems configured to provide gaming elements and/or gaming components. Note that different types of educational content may include gaming elements.

The content creation module may be configured to allow a user to create and add educational content. Additional educational content may include customized components of educational content based on XML files that describe the objectives and/or game-play mechanics of said components. Alternatively, and/or simultaneously, additional educational content may include learning objects. A learning object may be implemented as an XML file that includes one or more of text, animations, videos, interactivity, or quizzes. A learning object may be portable to a variety of client computing devices and computing platforms. The content creation module may be configured to import a file—such as a file comprising a learning object—in a standardized format, e.g. XML, for use as a component of educational content within the educational virtual space.

The currency module may be configured to facilitate the use of a virtual currency in the educational virtual space. Virtual currency (held in credit for a user) may be used to acquire virtual goods in the virtual space, which may add to a user's virtual inventory. Virtual currency may be won through a particular achievement, such as completion of a particular component of the curriculum, awarded by a teacher, or obtained through other means. Virtual goods may include avatars, virtual items and/or abilities for an avatar, buzzpods (or means for transportation within the virtual space) or items and/or abilities for a buzzpod (or for a means for transportation within the virtual space), virtual objects, visual themes, and/or other virtual goods.

The leaderboard module may be configured to provide ordered listings comparing one or more students to each other. For example, the leaderboard module may use performance information for all students in a class, e.g. related to a particular game, and provide a ranking thereof.

These and other objects, features, and characteristics of the present disclosure, as well as the methods of operation and functions of the related components of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the any limits. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to provide an educational virtual space to teachers and students.

FIG. 2 illustrates exemplary embodiments of a teacher interface within an educational virtual space.

FIG. 3 illustrates exemplary embodiments of a student interface within an educational virtual space.

FIG. 4 illustrates a method of providing a virtual space to users.

FIG. 5 illustrates a method of setting up accounts within an educational virtual space.

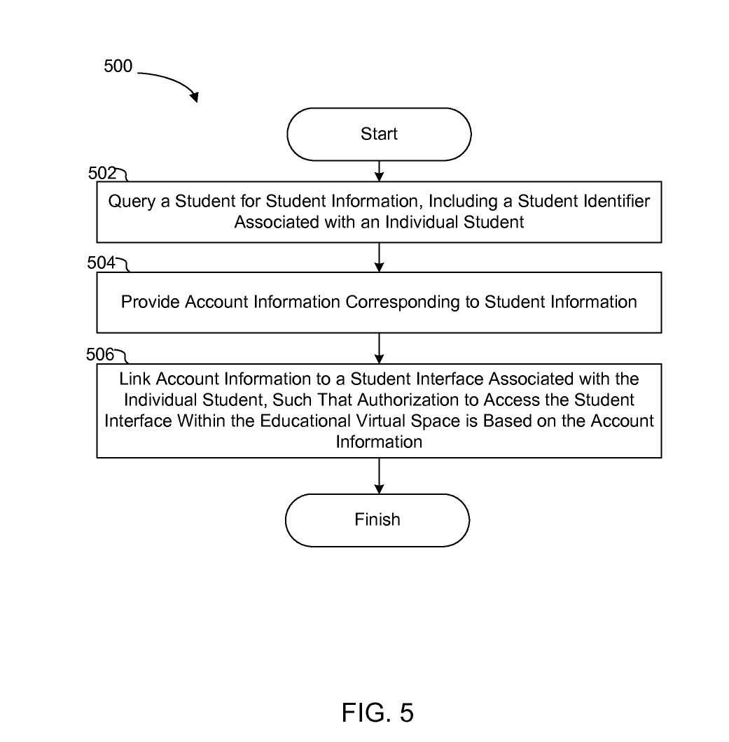

FIG. 6 illustrates a method for guiding students through educational components within an educational virtual space.

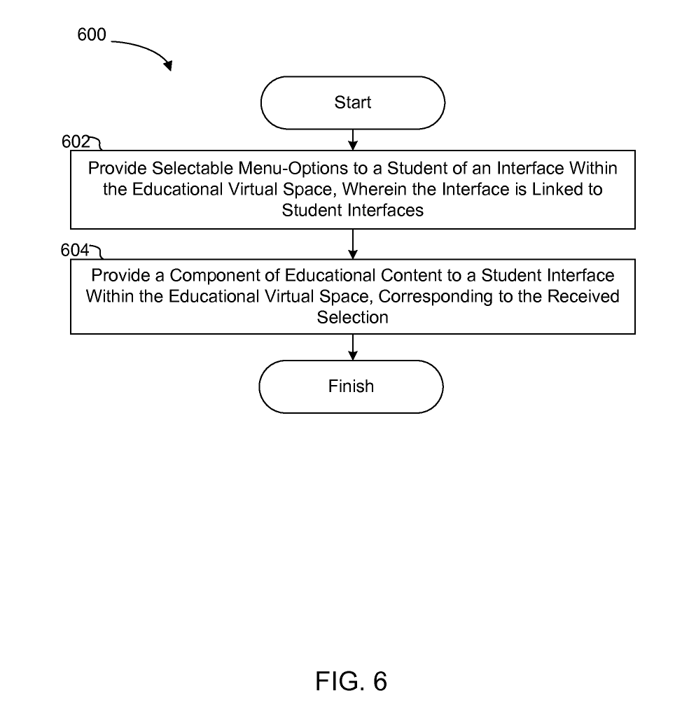

FIG. 7 illustrates a method for guiding students through educational components within an educational virtual space.

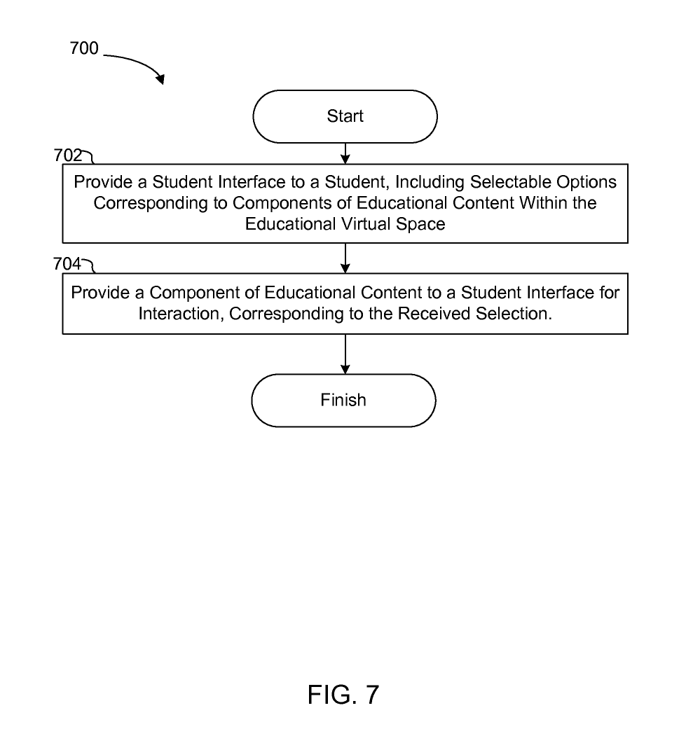

FIG. 8 illustrates a hierarchy of conceptual levels used for components of educational content within the education virtual space.

### DETAILED DESCRIPTION

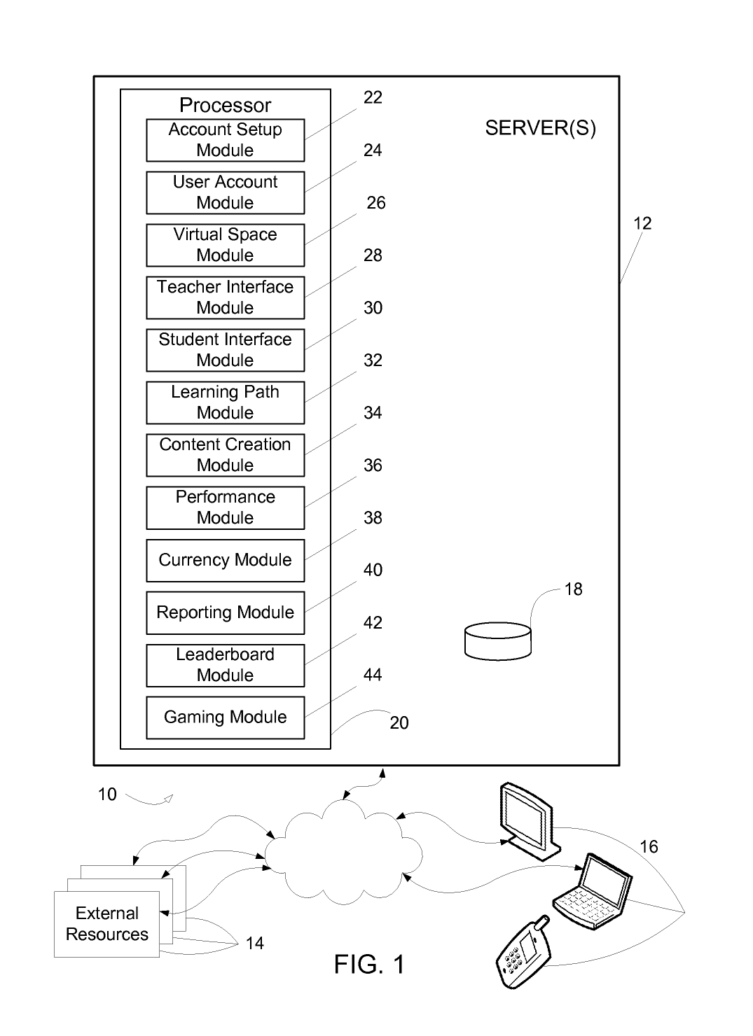

FIG. 1 illustrates a system 10 configured to provide an educational virtual space to teachers and students. Teachers and students may be collectively referred to as users. As used herein, a “virtual space” may refer to an environment provided to users over a network. The educational virtual space may include multiple (virtual) places or (virtual) locations that may be inter-connected to each other. The educational virtual space may be used by one or more teachers, to guide one or more students through a (multi-day) curriculum including educational content. The educational virtual space may be used to engage students in data-driven learning explorations. The virtual space may enable synchronous and/or asynchronous interactions, public, private, and/or semi-private interactions, text-based interactions, audio-based interactions, computer-graphics-based interactions, video-based interactions, and/or other interactions. The educational virtual space may be a virtual space in which educational content is provided, (educational) games are played, in which users communicate with each other, in which users experience different characters and challenges, and/or in which other activities are conducted. The educational virtual space may be embedded, integrated, linked, and/or otherwise combined with a social virtual world and/or a social network. Providing the virtual space may include hosting the virtual space over a network.

A teacher and one or more students may be enabled to interact in the same virtual space, with the teacher being enabled to guide students through a sequence of daily curricula controlled by the teacher. Through this experience, usage of the educational virtual world promotes critical and creative thinking skills for students, which helps students master specific content aligned to state and Common Core Standards. The sequence of daily curricula may be referred to as an epoch, e.g. consisting of five 1-day curricula. A sequence of epochs may be referred to as an era. Each era, a sequence of epochs may be begun anew. Different eras may correspond to different educational concepts, and have different and/or similar lengths, such as one week. Different epochs may include different structure, different components of educational content, different lengths, etc. Some parts of a daily curriculum may be designed to be completed independently by a student, whereas other parts may be designed to require direct control through a teacher interface, and/or user collaboration as provided within the educational virtual space. A (multi-day) curriculum may focus on specific educational concepts and/or content areas. For example, a math-centric curriculum may focus on algebra, geometry, number sense, and/or other content areas.

System 10 may instance a user interface specific to a new user in response to receiving confirmation that a new user has joined the educational virtual space. For example, when system 10 “logs in” a student, a personal instance of a student interface may be provided to the student, e.g. via a personal client computing platform and/or device.

System 10 may include one or more servers 12, and/or other components. Processor(s) 20 may be configured to provide information processing capabilities in server 12. As is shown in FIG. 1, processor 20 may be configured to execute one or more computer program modules. The one or more computer program modules may include one or more of an account setup module 22, a user account module 24, a virtual space module 26, a teacher interface module 28, a user interface module 30, a learning path module 32, a content creation module 34, a performance module 36, a currency module 38, a reporting module 40, a leaderboard module 42, a gaming module 44, and/or other modules.

Account setup module 22 may be configured to create and/or link user accounts. The functionality provided by account setup module 22 may be accessed through a dedicated software program, a URL, a menu-option in a virtual space, a menu-option in a teacher interface, and/or other types of access. Account setup module 22 may be configured to create teacher accounts based on input received from teachers. Account setup module 22 may be configured to create student accounts that are linked to at least one particular teacher account based on input received from teachers. For example, account setup module 22 may generate a user interface for presentation to a teacher that includes a selectable menu-option within a teacher interface. In response, account setup module 22 may provide one or more fields for a teacher to provide student information. The fields may include one or more of a text entry field, a set of selectable menu items, a selectable field, and/or other fields configured to receive entry and/or selection from the teacher. For example, the fields may be configured to receive entry and/or selection of student name, student gender, class name, and/or other student information.

A newly created student account may be implicitly linked to a teacher account. Alternatively, the fields may be configured to receive selection and/or entry of teacher information for the purpose of establishing such a link. Upon entering the student information, account setup module 22 may supply student account access information (e.g. user name and password) for the newly created student account. Student account access information may be supplied by account setup module 22 via email to e.g. a teacher, via display within a user interface, and/or via other means of supply. For privacy and safety considerations, server 12 may be configured not to store the student account access information. In certain embodiments, the functionality of account setup module 22 may be accessible to students responsive to student account access information being entered. For example, the first occurrence of student account access information being entered may activate a student account.

User account module 24 may be configured to act as a repository of user information. User information may include provided information of a user, stated information, account information of a user, virtual space settings and/or preferences of a user, information derived by analysis, past interactions/achievements/evaluations pertaining to a user/teacher/lesson/curriculum, educational information of a user, account history of a user, and/or other user information. User information for students may include no personal information. User account module 24 may be configured to enable users to select avatars to represent them in the virtual space. Personal user choices for avatars, virtual decorations, and/or other virtual goods may be included as user information stored by user account module 24. User account module 24 may be configured to enable users to select a so-called buzzpod, which is a virtual means of transportation within the educational virtual space.

Virtual space module 26 may be configured to provide or host a virtual space to users such that users are able to interact and collaborate with each other in addition to interacting with the educational content. Virtual space module 26 may communicate with instances of a user interface that are specific to a user. Educational content may be a curriculum comprising warm-up sessions, lessons, practices, games, quizzes, quests, challenges, worksheets, other in-space educational content, and/or offline educational content such as, e.g., home work assignments. Educational content may be adapted to a user. The virtual space may be depicted as a graphical user interface including a variety of selectable menu-options and/or selectable user actions. For example, selection of a menu-option may initiate collaboration with another user (through chatting, instant-messaging, sharing research, jointly creating a document/presentation/play, traveling throughout the virtual space, and/or other ways to collaborate) or start a lesson or game. As another example, selection of a user action may move a user's avatar (or a user's buzzpod) to a new location/place within the virtual space or interact with virtual objects in the virtual space. The educational virtual space may support the creation of a play, which may be acted out by avatars and/or other virtual objects manipulated by users (e.g. in real-time) and broadcast or made available for viewing to users.

Virtual space module 26 may be configured to determine views of various places within the virtual space for a user. The views may then be communicated (e.g. via streaming, via object/position data, and/or other information) from server 12 to client computing platforms 16 for presentation to users. The view determined and transmitted to a given client computing platform 16 may correspond to a user's avatar being controlled by a user via the given client computing platform 16. The view determined and transmitted to a given client computing platform 16 may correspond to a location in the virtual space (e.g., the location from which the view is taken, the location the view depicts, and/or other locations), a zoom ratio, a dimensionality of objects, a point-of-view, and/or view parameters. One or more of the view parameters may be selectable by the user.

The virtual space may comprise a simulated space (e.g., similar to a physical space, which may be segmented into spatially separate areas) that are accessible by users via clients (e.g., client computing platforms 16) that present the views of the virtual space to a user. Separate places in the virtual space may be depicted, for example, as separate islands, rooms, neighborhoods, cities, arenas or stadiums, and/or other places. The simulated space of the virtual space may have a topography, express ongoing real-time interaction by one or more users, and/or include one or more objects positioned within the topography that are capable of locomotion within the topography. In some embodiments, the topography may be a 2-dimensional topography. In some embodiments, the topography may be a 3-dimensional topography. The topography may describe a surface (e.g., a ground surface) that runs through at least a substantial portion of the place. The topography may describe a volume with one or more bodies positioned therein (e.g., a simulation of gravity-deprived space with one or more celestial bodies positioned therein). The user interface instances may be synchronous, asynchronous, and/or semi-synchronous.

Teacher interface module 28 may be configured to control—as directed by a teacher, an administrator, an aid, a classroom supervisor, and/or other users—educational content and/or the (daily) curriculum, for one or more students. Teacher interface module 28 may be configured to control settings and/or features pertaining to operations and/or interactions in the educational virtual space, for one or more students. Teachers may exercise control through control inputs and/or commands input by the teachers through client computing platforms 16. For example, a particular lesson, practice, game, quiz, quest, challenge, worksheet, and/or other type of educational content may be selectable through teacher interface module 28 in order to start said educational content for one or more students within the educational virtual space. Teacher interface module 28 may be configured to control a level of difficulty of a component of educational content, for one or more students. Such control may be manual, automatic, programmable, or otherwise changeable in a predetermined manner. Through teacher interface module 28, mastery of a particular educational concept, as evidenced by pertinent performance information, may be required for a student to proceed to another component of educational content within the educational virtual space.

As used herein, “warm-up session”, “lesson”, “practice”, “game”, “quiz”, “quest”, “worksheet”, and “challenge” refer to components of a curriculum that may be provided to a student through the educational virtual space. “Warm-up session” may refer to instructions or directions—as provided by one of the computer program modules of system 10—pertaining to a physical routine of a few minutes that is intended to invigorate and engage students physically in the real world, while being conceptually linked to other components of a curriculum and/or an educational component within the educational virtual space (e.g., the daily curriculum).

“Lesson” may refer to instruction of educational concepts. Lessons may be interactive, and use illustrated or animated contents to facilitate understanding and aid comprehension. For example, a lesson may include narrated and/or written instruction provided within the educational virtual space, and may be self-paced by individual students. A lesson may adapt to the learner.

“Practice” may refer to a set of content based on a prior lesson. Such content may include problems, questions, queries, examinations, puzzles, and/or other ways to test a student's comprehension, e.g. of the educational concepts covered in a lesson. Interactions by users with the content associated with a practice may receive instant feedback. A user-interface of system 10 may be configured to present a student with results and/or an evaluation of the practice (e.g. how many questions were answered correctly on the first try, total time to complete the test, etc.) after completion.

“Game” may refer to an educational activity within the virtual space that requires understanding of a particular educational concept to complete. Games may include puzzles, resource-management games, strategic games, problem-solving games, tower-defense games, combat games, shooting games, racing games, physics-based games, mission-based games, and/or other types of games. Games may provide a student with an opportunity to earn virtual currency.

“Quest” may refer to a (daily) challenge that requires students to use their avatars to apply skills and concepts (previously honed through lessons, practices, and/or games) to accomplish a particular task within the virtual space. Quests may involve interactions and/or collaborations with characters within the virtual space, as well as other students. Quests may provide a student with an opportunity to earn virtual currency.

“Worksheet” (or “challenge”) may refer to a test within the educational virtual space intended to determine a students level of comprehension. A worksheet may be presented within a view of the virtual space (e.g., as a paper or monitor being viewed by a user controlled avatar), as a separate screen view, and/or through other presentation mechanisms. User interfaces within system 10 may be configured to provide students and teachers with instant feedback during (completion of) a worksheet. For example, teacher interface module 28 may be configured to provide cumulative performance information for multiple worksheets and/or students. The format of a worksheet may be designed to mimic standardized testing formats. A worksheet or challenge may include “writing in math” questions, e.g. using the so-called Four Square approach to answering writing and/or response questions.

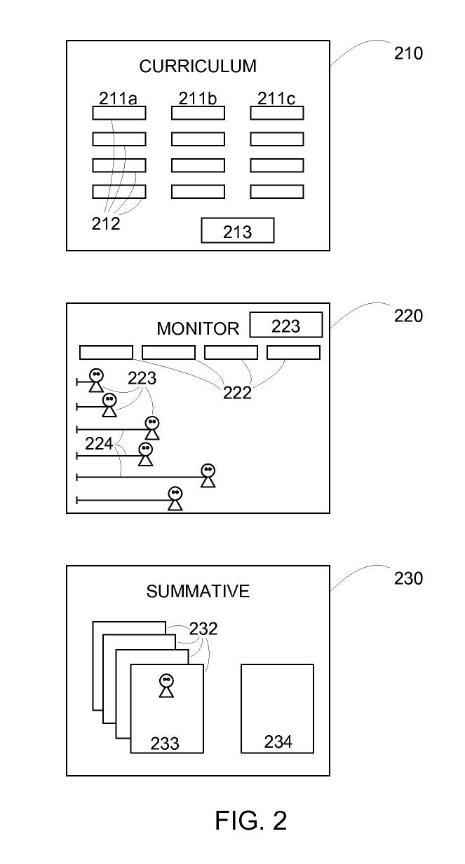

By way of illustration, FIG. 2 illustrates exemplary embodiments of a teacher interface within an educational virtual space, as may be provided by teacher interface module 28. For example, graphical interface 210 illustrates a “CURRICULUM” view, which may include multiple daily curricula 211a, 211b, 211c, each comprising multiple components 212 of educational content. Components 212 may be a lesson, practice, quiz, etc. specific to a particular daily curriculum. A component 212 may be selected, e.g. through teacher interface module 28, to start that component for one or more students. Once component 212 is started, it may proceed autonomously for each student (i.e. self-paced), or in a synchronized fashion under control through teacher interface module 28. An additional item 213 may e.g. provide control over settings or features available to the students within the education virtual space, such as e.g. chat.

A curriculum may include multiple daily curricula within the educational virtual space, as well as educational components outside of the educational virtual space, such as, e.g. classroom discussions, home work, etc. The curriculum shown in graphical interface 210 may provide a learning path for one or more students (i.e. a sequence of components 212 of educational content, starting with the components under daily curriculum 211a, proceeding to the components under daily curriculum 211b, and continuing with the components under daily curriculum 211c). The learning path may be the same for all students, or may be adapted for individual students (automatically and/or manually), e.g. through teacher interface module 28.

Student interface module 30 may be configured to generate a student user interface that is provided to the users via the client computing platforms 16. The student user interface may facilitate student interaction and/or provide access for a student to views of the educational virtual space, a (daily) curriculum selected through teacher interface module 28, (components of) educational content, a user's student account access information, user information (e.g. stored by user account module 24), and/or other information. The student user interface may be configured to receive control inputs and/or commands input by the students through client computing platforms 16. Such controls and/or inputs may be implemented by virtual space module 26 and/or other modules to control the virtual space and/or objects positioned therein.

A student interface may be differentiated for different parts of an epoch, as described in relation to learning path module 32. For example, students may be enabled to control their avatars directly through their respective student interface modules during the first four days of an epoch, whereas they may be enabled to control their buzzpods directly during the last day of the epoch. Note that interaction between students may enhance the educational content and/or the coherence thereof.

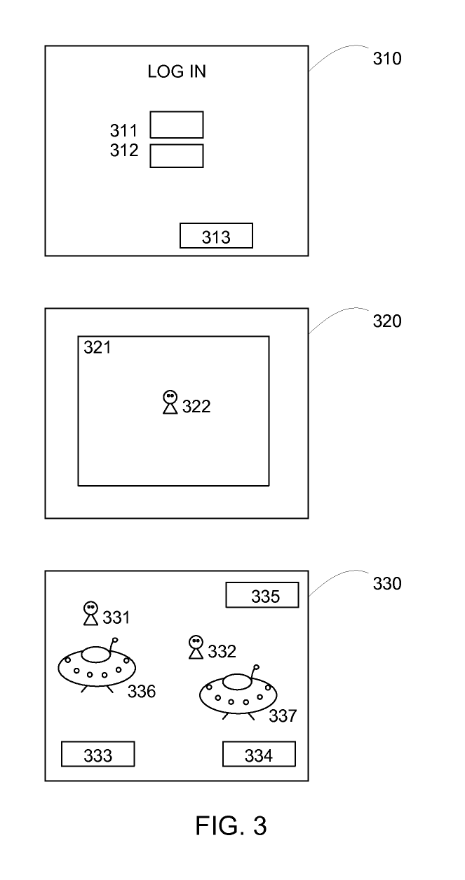

By way of illustration, FIG. 3 illustrates exemplary embodiments of a student interface within an educational virtual space, as may be provided by student interface module 30. For example, graphical interface 310 illustrates a “LOG IN” view, which may include fields 311, 312, and/or other fields used to authorize student access to system 10, the educational virtual space, and/or other components or features described herein. Additional item 313 may e.g. provide control over settings or features available to a student within the educational virtual space, such as e.g. a menu of available curricula and/or classes.

By way of further illustration, graphical interface 320 illustrates a view of an educational component 321, such as a lesson or educational game, as may be provided to a student through student interface module 30. Avatar 322 may represent the user.

Graphical interface 330 illustrates a view of a student interface for the educational virtual space, which may be provided during the last day of an epoch. Avatar 331 and avatar 332 may represent different students concurrently interacting within the virtual space. Buzzpod 336 and buzzpod 337 may represent virtual means of transportation within the virtual space, and may be available to avatar 331 and avatar 332, respectively. Alternatively, buzzpod 336 and buzzpod 337 may be available to other avatars not explicitly depicted in graphical interface 320. Item 333 may e.g. represent an component of educational content that is currently available to a student. Item 334 may e.g. represent a selectable action available through a student interface module, such as e.g. moving the avatar (or buzzpod) representing (or “transporting”) the student to a different place/location/view within the educational virtual space. Another action that may be started through item 334 may be a chat-session with one or more other users. Additional item 335 may e.g. represent information related to personal user information, such as a student's virtual inventory, available virtual currency, progress level, and/or other personal user information.

Performance module 36 may be configured to track a student's performance on various parts of the curriculum and/or derive or compile performance information for a student or group of students. Performance information may be based on teacher input in addition to events that transpired within the education virtual space. Performance information may be made available to teachers, administrators, and/or other appropriate interested parties. Performance information may include an evaluation of a student's progress through a component of educational content, such as e.g. a quiz. Educational content within the educational virtual space may be organized according to educational concepts, which may in turn be organized according to a hierarchy of conceptual levels. Statistics based on performance information, for one or more students, may be available for review at different levels within the hierarchy of conceptual levels.

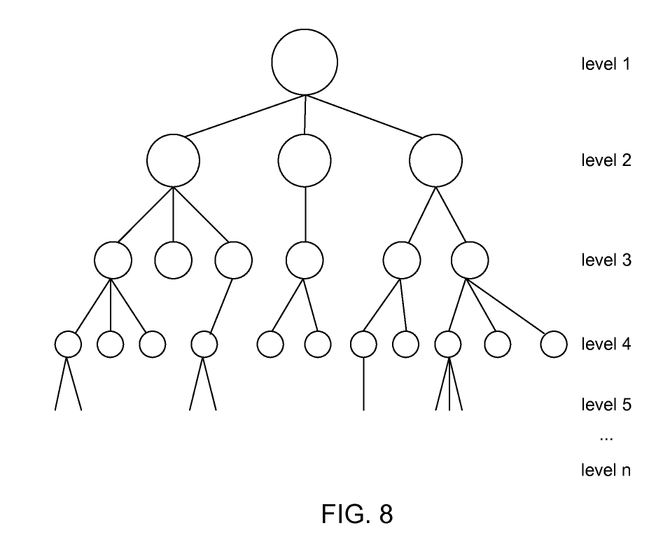

Performance module 36 may be configured to perform a granular assessment of a student's progress. For example, granular assessment may determine, e.g. through statistical analysis, whether the distribution of incorrect answers during one or more quizzes/practice-sessions indicates a particular area (i.e. an educational concept and/or content area and/or a constituent component thereof) of less-than-average comprehension for a student. The areas analyzed for the purpose of granular assessment may correspond to (components of) standardized tests as commonly used to assess conceptual comprehension. By way of illustration, FIG. 8 illustrates a hierarchy of conceptual levels that may be used for components of educational content within the educational virtual space. For example, level 1 may include mathematics. Level 2 may include a category within mathematics, such as algebra, geometry, number sense, etc. Level 3 may include sub-categories within a level-2 category, such as fractions. Level 4 may include aspects within a level-3 sub-category, such as subtracting fractions, imperfect fractions, etc. Level 5 may include sub-aspects within a level-4 aspect, and so on and so forth, for any number of levels.

Quantifying performance for a particular area provides an opportunity for targeted improvement, review, and/or practice, e.g. through additional educational content within the educational virtual space specifically geared to improve the level of comprehension of the student in said particular area. Such targeted educational content may be referred to as granular assignment. Alternatively, and/or simultaneously, if a student's level of comprehension is determined to be sufficiently advanced, (granular) assessment may indicate the student is ready to proceed to more advanced/challenging educational material in order to expand the student's level of comprehension. Such educational material may also be referred to as granular assignment. Performance module 36 may operate in conjunction with other computer program modules, such as e.g. learning path module 32, to achieve the stated goals and functionality.

Performance module 36 may be configured to export performance information in a format suitable for systems outside system 10 and/or the virtual space. In certain embodiments, performance module 36 may be configured to import performance information, e.g. based on standardized tests, from systems outside of system 10. External performance data may be student specific and/or pertaining to multiple students. Performance module 36 may incorporate external performance data to determine performance information for a student.

Reporting module 40 may be configured to present and/or export any information from any module within system 10 configured to provide the educational virtual space to a teacher, student, and/or other party, within appropriate bounds. Reporting module 40 may aggregate some or all of the information, e.g. provide the average score of, e.g. a game played by an entire class.

Leaderboard module 42 may be configured to provide ordered listings comparing one or more students to each other. For example, leaderboard module 42 may use performance information for all students in a class, e.g. related to a particular game, and provide a ranking thereof.

Teacher interface module 28 may be configured to generate a user interface for teachers that conveys the progress of students during the curriculum in real-time and/or after completion of a particular part of the curriculum. Information conveying progress may include, for a given student, one or more of times at which the given student is active in the virtual space, areas of the virtual space the given student views or interacts with or in, other students the given student interacts with, the nature and/or content of interactions of the given student with other students, activities participated in within the virtual space, level, powers, or skill attained in the virtual space, inventory items obtained in the virtual space, and/or other interactions of the given student with the virtual space and/or other students. Some or all of the information generated through monitoring the interactions of the students may be stored as user information managed by e.g. user account module 24.

The user interface provided by teacher interface module 28 may provide control over optional features in the educational virtual space, such as inter-user chat. By way of illustration, FIG. 2 illustrates exemplary embodiments of a teacher interface within an educational virtual space, as may be provided by teacher interface module 28 (as shown in FIG. 1 and described herein). For example, graphical interface 220 illustrates a “MONITOR” view, which may include one or more components 222 of educational content, which may be part of the same daily curriculum. Components 222 may jointly form a single component of educational content from a daily curriculum. Avatars 223 may represent different students currently interacting with components 222. Progress bars 224 may indicate the progress for a student represented by an avatar.

Graphical interface 220 in FIG. 2 may provide a user with the option to reorder the listed students in graphical interface 220 in a particular order. Students may be listed alphabetically on first name, last name, or user name. Students may be listed in order of their relative performance ranking, as based on one or more components of educational content. Students may be listed in other orders. One or more avatars may be moved within graphical interface 220 by the user (e.g. by “drag-and-drop”) to align with a particular component 222 in order to control the educational content provided accordingly to said student(s), e.g. to initiate a particular component 222 for the student(s). Graphical interface 220 may provide an easy overview (real-time or otherwise) of the relative level of progress of a group of students. Additional item 223 may e.g. provide control over settings or features available to the students within the education virtual space, such as e.g. pausing/resuming the current component 222 for one or more students. Selection of a particular avatar 223 (e.g. by double-clicking on said avatar) may display user information or other information related to the student represented by said avatar, e.g. by invoking graphical interface 230.

By way of illustration, graphical interface 230 illustrates a “SUMMATIVE” view, which may include multiple components 232 of student information, e.g. item 233 may provide student information for the student represented by the avatar shown in item 233. Additional item 234 may e.g. provide control over settings or features available to a teacher within the education virtual space, such as e.g. adding a new student (account) to a class, or setting levels of difficulty pertaining to the components of educational content intended for a particular student or multiple students.

Learning path module 32 may be configured to chart or provide an initial learning path (i.e. a sequence of components of educational content that are part of a curriculum) for a student, based on e.g. the (daily) curriculum selected by the teacher. An initial learning path may be based on structured groups of daily curricula called epochs. An epoch may for example comprise four daily curricula intended to introduce a particular educational concept, followed by one daily curriculum intended to test and/or review said educational concept. An initial learning path may be based on an era of epochs. An era may e.g. have a duration of one month, a trimester, a semester, and/or other durations that are longer than the constituent epochs. By charting or providing an initial learning path for a considerable duration of time, the coordination and/or coherence of the educational content may be enhanced. An initial learning path may include settings such as a particular level of difficulty for some or all of the educational content that is part of the initial learning path.

As the student progresses through a daily curriculum, epoch, and/or era, learning path module 32 may automatically and/or manually (under control of e.g. teacher interface module 28) adapt the learning path—thus creating a flexible learning path or adaptive learning path—based on student performance, performance information, teacher input, and/or other information. This adaptation may occur continuously, intermittently, periodically, ad hoc, as scheduled, and/or at other moments. Learning path module 32 may of course operate in conjunction with other computer program modules, such as e.g. performance module 36, to achieve the stated goals and functionality.

Learning path module 32 may be configured to create and/or provide educational materials and/or instructions, e.g. to a teacher, that are intended to augment the scholastic experience provided through use of the educational virtual space and/or through a student's interaction with the educational virtual space. These educational materials and/or instructions may include educational components designed to take place outside of the educational virtual space. The instructions may include directions, activity type, time allotted, physical materials needed, and/or other instructions. By teaching educational concepts, such as e.g. a mathematical operation, under different circumstances, such as online (within the virtual space), and offline (e.g. home work or class room discussions), students may gain improved comprehension of said concept. This process may be referred to as blended learning. Blended learning may include higher order thinking discussions (prompted by higher order thinking discussion questions that may be provided to a teacher by learning path module 32) that require students to think critically about questions, skills, and concepts. Blended learning may also include other types of activities to supplement educational content, e.g. to supplement online learning. Higher order thinking discussions may e.g. give students an opportunity to apply theoretical skills to real life situations.

Gaming module 44 may be configured to provide gaming elements and/or gaming components within the system configured to provide the educational virtual space. Alternatively, and/or simultaneously, gaming module 44 may provide a link from the educational virtual space to external systems configured to provide gaming elements and/or gaming components. Note that different types of educational content may include gaming elements.

Content creation module 34 may be configured to allow a user to create and add educational content. Additional educational content may include custom quests based on XML files that describe the objectives and/or game-play mechanics. Alternatively, and/or simultaneously, additional educational content may include learning objects. A learning object may be implemented as an XML file that includes one or more of text, animations, videos, interactivity, or quizzes. A learning object may be portable to a variety of client computing devices and computing platforms. Content creation module 34 may be configured to import a file—such as a file comprising a learning object—in a standardized format, e.g. XML, for use as a component of educational content within the educational virtual space.

Currency module 38 may be configured to facilitate the use of a virtual currency. The virtual currency may be used as a rewards system in the virtual space. Virtual currency (held in credit for a user by currency module 38) may be used to acquire virtual goods in the virtual space, which may add to a user's virtual inventory. Virtual currency may be won through a particular achievement, such as completion of a particular component of the curriculum, awarded by a teacher, or obtained through other means. Virtual goods may include avatars, virtual items and/or abilities for an avatar, buzzpods (or means for transportation within the virtual space) or items and/or abilities for a buzzpod (or for a means for transportation within the virtual space), virtual objects, visual themes, and/or other virtual goods.

As is shown in FIG. 1, system 10 may operate in communication and/or coordination with one or more external sources 14. Users may interface with system 10 and/or external resources 14 via client computing platforms 16. The components of system 10, servers 12, external resources 14, and/or client computing platforms 16 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which servers 12, external resources 14, and/or client computing platforms 16 may be operatively linked via some other communication media.

A given client computing platform 16 may include one or more processors configured to execute computer program modules. The computer program modules may be configured to enable one or more users associated with the given client computing platform 16 to interface with the educational virtual space, system 10, and/or external resources 14, and/or provide other functionality attributed herein to client computing platforms 16. By way of non-limiting example, the given client computing platform 16 may include one or more of a desktop computer, a laptop computer, a tablet computing device, a handheld computer, a NetBook, a smartphone, a gaming console, and/or other computing platforms.

External resources 14 may include sources of information (e.g. dictionaries or encyclopedias), hosts and/or providers of virtual spaces outside of system 10, external entities participating with system 10, and/or other resources. In some implementations, some or all of the functionality attributed herein to external resources 14 may be provided by resources included in system 10.

The server 12 may be configured to provide a virtual space to users, or cooperate with client computing platforms 16 to provide a virtual space to users. This may include hosting, serving, and/or otherwise providing the virtual space within which interaction between users is facilitated via client computing platforms 16. The server 12 may include electronic storage 18, one or more processors 20, and/or other components. The server 12 may include communication lines, or ports to enable the exchange of information with a network and/or other computing platforms.

Electronic storage 18 may comprise electronic storage media that electronically stores information. The electronic storage media of electronic storage 18 may include one or both of system storage that is provided integrally (i.e., substantially non-removable) with server 12 and/or removable storage that is removably connectable to server 12 via, for example, a port (e.g., a USB port, a FireWire port, etc.) or a drive (e.g., a disk drive, etc.). Electronic storage 18 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 18 may store software algorithms, information determined by processor 20, information processed, controlled, monitored, obtained, identified, derived, gathered, communicated, adjusted, adapted, included, and/or provided by one or more computer program modules, information received from server 12, information received from client computing platforms 16, information received from external resources 14, and/or other information that enables server 12 to function properly.

Processor(s) 20 may be configured to provide information processing capabilities in server 12. As such, processor 20 may include one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some implementations, processor 20 may include a plurality of processing units. These processing units may be physically located within the same device, or processor 20 may represent processing functionality of a plurality of devices operating in coordination. Processor 20 may be configured to execute modules 22, 24, 26, 28, 30, 32, 34, 36, and/or 38 by software; hardware; firmware; some combination of software, hardware, and/or firmware; and/or other mechanisms for configuring processing capabilities on processor 20.

It should be appreciated that although modules 22, 24, 26, 28, 30, 32, 34, 36, and 38 are illustrated in FIG. 1 as being co-located within a single processing unit, in implementations in which processor 20 includes multiple processing units, one or more of modules 22, 24, 26, 28, 30, 32, 34, 36, and/or 38 may be located remotely from the other modules. The description of the functionality provided by the different modules 22, 24, 26, 28, 30, 32, 34, 36, and/or 38 described below is for illustrative purposes, and is not intended to be limiting, as any of modules 22, 24, 26, 28, 30, 32, 34, 36, and/or 38 may provide more or less functionality than is described. For example, one or more of modules 22, 24, 26, 28, 30, 32, 34, 36, and/or 38 may be eliminated, and some or all of its functionality may be provided by other ones of modules 22, 24, 26, 28, 30, 32, 34, 36, and/or 38. As another example, processor 20 may be configured to execute one or more additional modules that may perform some or all of the functionality attributed below to one of modules 22, 24, 26, 28, 30, 32, 34, 36, and/or 38.

It will be appreciated that the illustration of modules 22, 24, 26, 28, 30, 32, 34, 36, and 38 being executed solely on processor 20 separate from client computing platforms 16 and external resources 14 is not intended to be limiting. For example, in some implementations, the client computing platforms 16 may be configured to provide locally at least some of the functionality attributed above to one or more of modules 22, 24, 26, 28, 30, 32, 34, 36, and/or 38. Similarly, one or more of modules 22, 24, 26, 28, 30, 32, 34, 36, and/or 38 may be executed locally on individual client computing platforms 16 while others are executed on server 12.

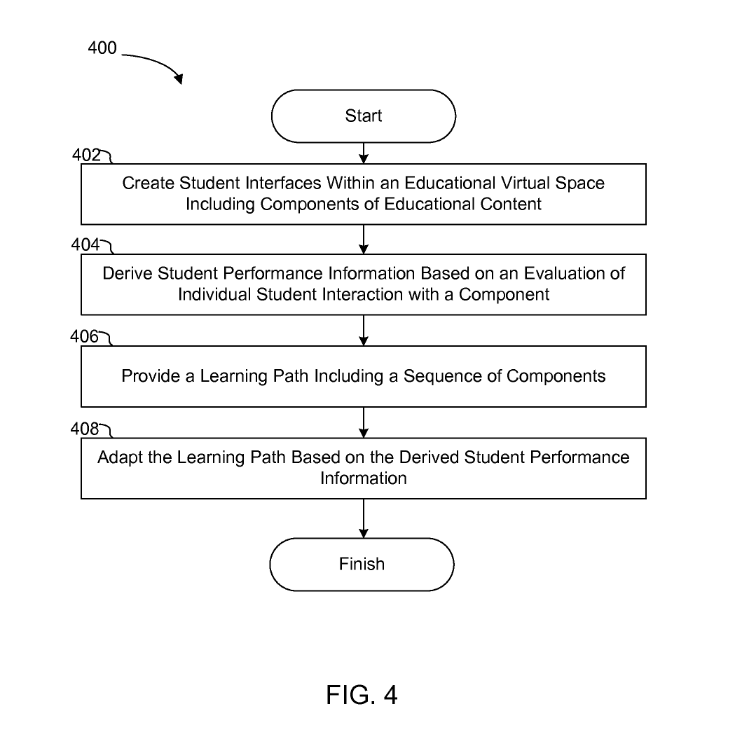

FIG. 4 illustrates a method 400 of hosting an educational virtual space. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, instances of separate student interfaces are created within the educational virtual space, wherein the educational virtual space includes components of educational content. The separate student interfaces may be associated with individual students. In some implementations, operation 402 may be performed by a virtual space module the same as or similar to virtual space module 26 (shown in FIG. 1 and described above).

At an operation 404, student performance information may be derived based on an evaluation of individual student interaction with a component of educational content. In some implementations, operation 404 may be performed by a performance module the same as or similar to performance module 36 (shown in FIG. 1 and described above).

At an operation 406, a learning path may be provided to a student, wherein the learning path includes a sequence of components of educational content. In some implementations, operation 406 may be performed by a learning path module the same as or similar to learning path module 32 (shown in FIG. 1 and described above).

At an operation 408, the learning path may be adapted based on the derived student performance information. In some implementations, operation 406 may be performed by a learning path module the same as or similar to learning path module 32 (shown in FIG. 1 and described above).

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system configured to host an educational virtual space, the system comprising:
one or more processors configured to execute computer program modules, the computer program modules comprising:
a virtual space module configured to communicate with separate student interfaces within the educational virtual space, wherein the separate student interfaces are associated with individual students, wherein the educational virtual space includes components of educational content;
a performance module configured to derive student performance information for individual students based on an evaluation of individual student interaction with a component of educational content; and
a learning path module configured to:
provide a learning path for individual students, wherein the learning path includes a sequence of multiple components of educational content, and
adapt the learning path for individual students based on the derived student performance information.

2. The system of claim 1, further comprising a teacher interface module configured to adjust the learning path for one or more students.

3. The system of claim 2, wherein the teacher interface module is further configured to control availability of features within the educational virtual space for individual students.

4. The system of claim 2, wherein the teacher interface module is further configured to monitor progress for individual students based on the student interaction with the sequence of multiple components of educational content.

5. The system of claim 4, wherein progress is represented by a graphical user interface that includes progress bars aligned with a representation of a sequence of components of educational content.

6. The system of claim 1, wherein the learning path module is further configured to provide complementary components of educational content for use outside the scope of the educational virtual space, wherein the complementary components of educational content complement the components of educational content within the educational virtual space.

7. The system of claim 1, wherein the virtual space module is further configured to facilitate collaboration between individual students within the educational virtual space, and wherein the components of educational content include a collaborative component that uses collaboration between individual students within the education virtual space.

8. A method of hosting an educational virtual space, the method comprising:
creating separate student interfaces within the educational virtual space, wherein the separate student interfaces are associated with individual students, and wherein the educational virtual space includes components of educational content;
deriving student performance information for individual students based on an evaluation of individual student interaction with a component of educational content;
providing a learning path for individual students, wherein the learning path includes a sequence of multiple components of educational content; and
adapting the learning path for individual students based on the derived student performance information.

9. The method of claim 8, further comprising adjusting the learning path for one or more students.

10. The method of claim 8, further comprising controlling availability of features within the educational virtual space for individual students.

11. The method of claim 8, further comprising monitoring progress for individual students based on the student interaction with the sequence of multiple components of educational content.

12. The method of claim 9, wherein progress is represented by a graphical user interface that includes progress bars aligned with a representation of a sequence of components of educational content.

13. The method of claim 8, further comprising providing complementary components of educational content for use outside the scope of the educational virtual space, wherein the complementary components of educational content complement the components of educational content within the educational virtual space.

14. The method of claim 8, further comprising facilitating collaboration between individual students within the educational virtual space, and wherein the components of educational content include a collaborative component that uses collaboration between individual students within the education virtual space.

15. A system configured to host an educational virtual space to client computing devices for interaction by students, the system comprising:
one or more processors configured to execute computer program modules, the computer program modules comprising:
a virtual space module configured to communicate with separate student interfaces within the educational virtual space, wherein the separate student interfaces are associated with individual students, and wherein the educational virtual space includes components of educational content;
a teacher interface module configured to control the components of educational content for the separate student interfaces.

16. The system of claim 15, wherein the teacher interface module is further configured to control availability of features within the educational virtual space for individual students.

17. The system of claim 15, further comprising a performance module configured to derive student performance information for individual students based on an evaluation of individual student interaction with a component of educational content.

18. The system of claim 17, wherein the teacher interface module is further configured to monitor progress for individual students based on student performance information.

19. The system of claim 18, wherein progress is represented by a graphical user interface that includes progress bars aligned with a representation of a sequence of components of educational content.

20. The system of claim 17, wherein the performance module is further configured to perform a granular assessment of student performance information to identify an area of less-than-average comprehension within a sequence of components of educational content.

21. The system of claim 15, wherein the components of educational content include one or more of a lesson, a game, a practice, a quiz, or a challenge.

22. A method of setting up accounts within an educational virtual space, the method comprising:
querying a student for student information, wherein the student information includes a student identifier associated with an individual student;
responsive to receiving the student information from the student, providing account information that corresponds to the student information; and
linking the account information to a student interface within the educational virtual space, wherein the educational virtual space includes components of educational content, such that authorization to access the student interface within the educational virtual space is based on the account information.

23. A method of guiding students through educational components within an educational virtual space, the method comprising:
providing selectable menu-options to a student through an interface within the educational virtual space, wherein the educational virtual space includes components of educational content, and wherein the interface of the student is linked to one or more student interfaces within the educational virtual space; and
responsive to receiving a selection of a selectable menu-option, provide a component of educational content to the one or more student interfaces for interaction, wherein the component corresponds to the received selection.

24. A method of guiding students through educational components within an educational virtual space, the method comprising:
providing a student interface within the educational virtual space to a student, wherein the educational virtual space includes components of educational content, and wherein the student interface includes selectable options corresponding to components of educational content within the educational virtual space;
responsive to receiving a selection of a selectable option, provide a component of educational content to the student interface for interaction, wherein the provided component corresponds to the selected option.
